(19) United States
(12) Patent Application Publication
(10) Pub. No.: US 2009/0139379 A1
(43) Pub. Date: Jun. 4, 2009

(54) Driver tool for driving various tool members

(75) Inventors: Wen Hung Chiang, Taichung Hsien (TW); Sheng Ming Chang, Taichung Hsien (TW)

Correspondence Address: CHARLES E. BAXLEY, ESQUIRE, 90 JOHN STREET, SUITE 309, NEW YORK, NY, 10038, US

(73) Assignee: Hsin Ying Enterprise Co., Ltd.

(21) Appl. No.: 11/998,658

(22) Filed: Nov. 30, 2007

(51) Int. Cl. B25B 23/00

(52) U.S. Cl. 81/438

(57) ABSTRACT

A driver tool includes a driver shank having a non-circular engaging hole formed in one end for changeably engaging with either of two end portions of a tool stem, and the end portions of the tool stem may be engaged with different tool members, a detent is slidably engaged in the driver shank for detachably anchoring the tool stem to the driver shank, a sleeve is slidably engaged onto the driver shank and biased by a biasing device for engaging with the detent and for selectively forcing the detent to engage with the tool stem and for detachably anchoring and securing the tool stem to the driver shank, and for allowing different tool members to be changeably rotated or driven by the driver shank.

### BACKGROUND OF THE INVENTION

1. Field of the Invention

The present invention relates to a driver tool, and more particularly to a driver tool for engaging with and for driving various tool bits or tool members having different sizes or dimensions, types, or the like.

2. Description of the Prior Art

Typical screw drivers or driver tools comprise a driver shank attached to or extended from a handle member for engaging with and for driving various tool bits or tool members. However, normally, the driver shank may be used to engage with and to drive a tool bit or tool member having a predetermined size or dimension or type, but may not be used to engage with and to drive the other tool bits or tool members having different sizes or dimensions, types, or the like.

The other screw drivers or driver tools comprise a driver shank detachably attached to a handle member and having two end portions for engaging with and for driving different tool bits or tool members.

For example, U.S. Pat. No. 5,819,612 to Anderson, U.S. Pat. No. 5,894,765 to Anderson et al., and U.S. Pat. No. 5,954,463 to Jore disclose three of the typical screw drivers or driver tools each comprising a reversible driver shank detachably attached to a handle member and having two end portions changeably engaging with the handle member for allowing either of the two end portions to engage with and to drive different tool bits or tool members.

However, the typical screw drivers or driver tools may only be used to engage with and to drive the tool bits or tool members having different sizes or dimensions, types, or the like, but may not be used to stably or solidly retain the fasteners to the tool bits or tool members, or may not be used to stably rotate or drive the fasteners.

The present invention has arisen to mitigate and/or obviate the afore-described disadvantages of the conventional screw drivers or driver tools.

### SUMMARY OF THE INVENTION

The primary objective of the present invention is to provide a driver tool provided for engaging with and for driving various tool bits or tool members having different sizes or dimensions, types, or the like.

In accordance with one aspect of the invention, there is provided a driver tool comprising a driver shank including a first end portion and a second end portion, and including a non-circular engaging hole formed in the first end portion thereof, a tool stem including two end portions for selectively engaging with the engaging hole of the driver shank, and including a non-circular engaging hole formed in each of the end portions of the tool stem for engaging with tool members, a magnetic member disposed between the engaging holes of the tool stem for engaging with and for attracting and for retaining the tool members to the tool stem, a detent slidably engaged in the driver shank and extendible into the engaging hole of the driver shank for engaging with the tool stem and for detachably anchoring and securing the tool stem to the driver shank, a sleeve slidably engaged onto the driver shank for selectively engaging with the detent and for selectively forcing the detent to engage with the tool stem and for detachably anchoring and securing the tool stem to the driver shank, and a biasing device for biasing the sleeve to engage with the detent and to force the detent to engage with the tool stem and to anchor the tool stem to the driver shank.

The biasing device includes a tubular member secured onto the driver shank, a barrel slidably engaged onto the driver shank and disposed between the tubular member and the sleeve for engaging with the sleeve, and a spring biasing member disposed between the tubular member and the barrel for engaging with the barrel and for biasing the barrel to engage with the sleeve.

The tubular member includes a retaining ring disposed on an outer peripheral portion thereof, and the barrel includes an inner peripheral recess formed therein for selectively engaging with the retaining ring and for limiting the barrel to slide relative to the tubular member.

The tubular member includes a peripheral rib extended radially and outwardly therefrom for selectively engaging with the barrel and for limiting the barrel to slide relative to the tubular member. The barrel includes an inner peripheral flange for engaging with the spring biasing member.

The sleeve includes a peripheral depression formed therein for selectively receiving and engaging with the detent and for allowing the detent to be disengaged from the tool stem and for allowing the tool stem to be detachably engaged into and disengaged from the engaging hole of the driver shank.

The sleeve includes a peripheral slot formed therein, and the driver shank includes a retaining ring disposed on an outer peripheral portion thereof for selectively engaging with the peripheral slot of the sleeve and for limiting the sleeve to slide relative to the driver shank and for preventing the sleeve from being disengaged from the driver shank.

The tool stem includes a peripheral groove formed in an outer peripheral portion thereof for engaging with the detent and for allowing the tool stem to be stably anchored and secured to the driver shank with the detent. The second end portion of the driver shank preferably includes a non-circular cross section for coupling to a driver tool.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a driver tool in accordance with the present invention;

FIG. 2 is a partial exploded view illustrating the operation of the driver tool;

FIG. 3 is a cross sectional view of the driver tool taken along lines 3-3 of FIG. 2;

FIG. 4 is a cross sectional view similar to FIG. 3 illustrating the operation of the driver tool;

FIGS. 5, 6 are further cross sectional views similar to FIGS. 3 and 4 illustrating the operation of the driver tool;

FIG. 7 is an exploded view similar to FIG. 1 illustrating the other arrangement of the driver tool;

FIG. 8 is a partial exploded view illustrating the driver tool as shown in FIG. 7;

FIG. 9 is a partial exploded and cross sectional view of the driver tool as shown in FIGS. 7 and 8; and

FIGS. 10, 11 are cross sectional views illustrating the operation of the driver tool as shown in FIGS. 7-9.

### DETAILED DESCRIPTION OF THE PREFERRED EMBODIMENT

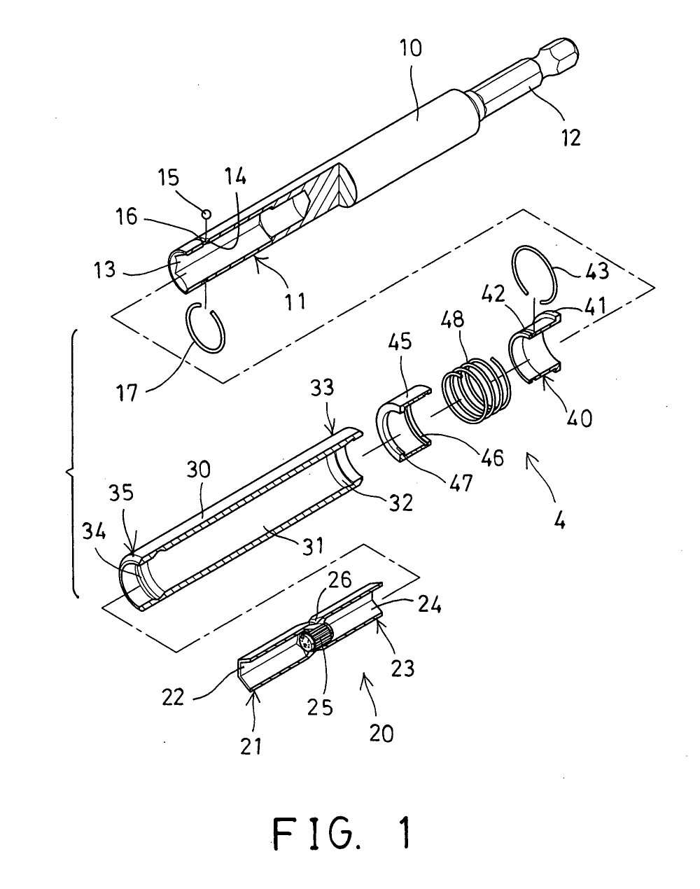

Referring to the drawings, and initially to FIGS. 1-3, a driver tool in accordance with the present invention comprises a driver shank 10 including two end portions 11, 12, in which one of the two end portions 12 includes a non-circular cross section for being coupled to a driving tool facility, such as a handle member of a screw driver, a power driving tool, or other driving tools, and for allowing the driver shank 10 to be rotated or driven by the driving tools. The driver shank 10 includes an engaging hole 13 formed in the other end portion 11 thereof and having a non-circular cross section for engaging with and for driving various tool bits or tool members. For example, a tool stem 20 includes two end portions 21, 23 for selectively or changeably engaging with or into the engaging hole 13 of the driver shank 10.

The two end portions 21, 23 of the tool stem 20 each include a non-circular outer cross section for engaging with the non-circular engaging hole 13 of the driver shank 10, and for allowing either of the two end portions 21, 23 of the tool stem 20 to be selectively or changeably rotated or driven by the driver shank 10, the tool stem 20 includes an engaging hole 22, 24 formed in each of the end portions 21, 23 thereof and each having a non-circular cross section, and the engaging holes 22, 24 of the tool stem 20 preferably include different sizes or dimensions or inner diameters for engaging with and for driving various tool bits or tool members 80, 88 of different sizes or dimensions or outer diameters or the like. The above-described structure is typical and will not be described in further details.

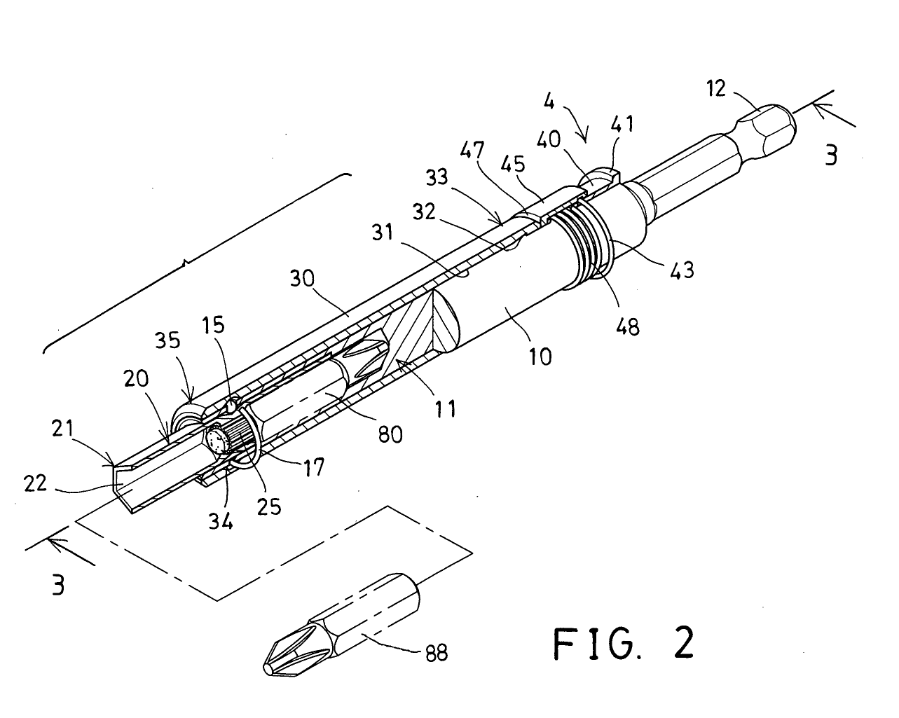

The tool stem 20 may further include a magnetic member 25 disposed or engaged therein and disposed between the engaging holes 22, 24 of the tool stem 20 for engaging with either or both the tool bits or tool members 80, 88 and for stably or solidly retaining the tool bits or tool members 80, 88 to the tool stem 20 and for allowing the tool bits or tool members 80, 88 to be stably or solidly rotated or driven by the tool stem 20, and may further includes a peripheral groove 26 formed in the outer peripheral portion thereof for anchoring purposes. For example, the driver shank 10 includes an orifice 14 formed therein (FIG. 1) and communicating with the engaging hole 13 of the driver shank 10 for slidably receiving or engaging with a ball or detent 15 which is extendible into the engaging hole 13 of the driver shank 10 for engaging with the peripheral groove 26 of the tool stem 20 (FIGS. 2-3, 5-6) and for detachably attaching or anchoring or securing the tool stem 20 to the driver shank 10.

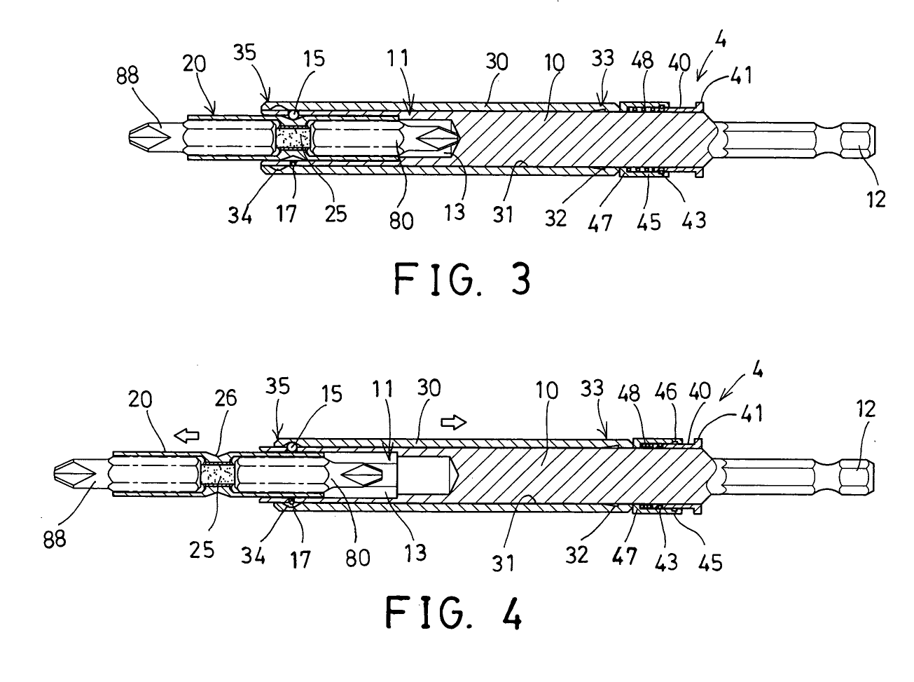

The driver shank 10 may further include a peripheral recess 16 formed in the outer peripheral portion thereof for engaging with a clamping or retaining ring 17 which may be offset or disengaged from the detent 15, or which may be attached or secured to the detent 15 for biasing or forcing the detent 15 into the engaging hole 13 of the driver shank 10 and to engage with the peripheral groove 26 of the tool stem 20 and thus for detachably attaching or anchoring or securing the tool stem 20 to the driver shank 10. A sleeve 30 may further be provided and includes a bore 31 formed therein for slidably engaging with or onto the driver shank 10 and for engaging with the detent 15 and for forcing the detent 15 to engage with the tool stem 20 (FIGS. 3, 6) and thus for detachably attaching or anchoring or securing the tool stem 20 to the driver shank 10.

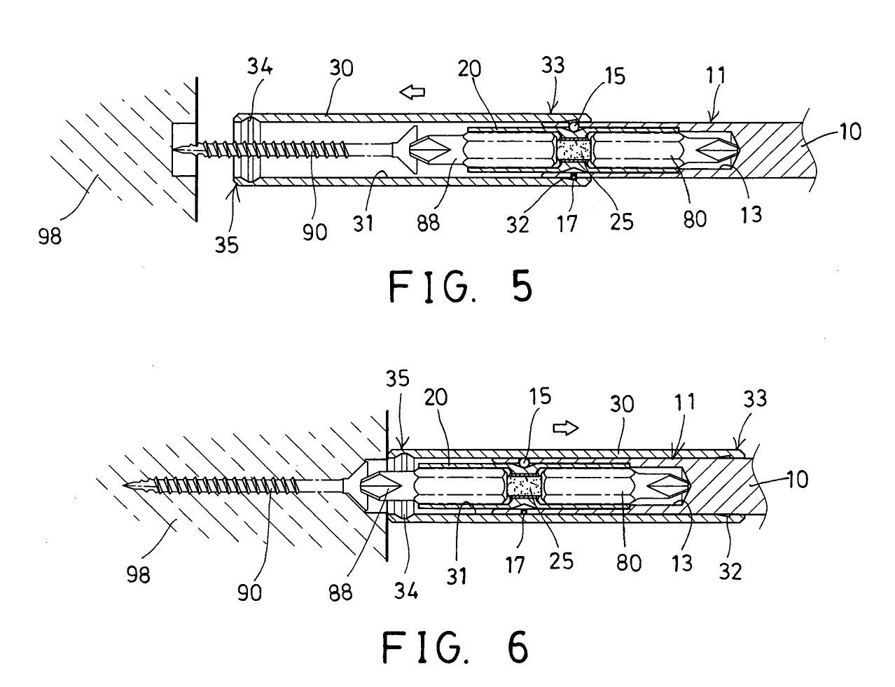

The sleeve 30 includes a peripheral slot 32 formed in one end portion 33 thereof for selectively engaging with the retaining ring 17 (FIG. 5) and for limiting the sleeve 30 to slide relative to the driver shank 10 and for preventing the sleeve 30 from being disengaged from the driver shank 10, and includes a peripheral depression 34 formed in the other end portion 35 thereof for selectively receiving or engaging with the detent 15 (FIGS. 2, 4) and for allowing the detent 15 to be disengaged from the tool stem 20 and thus for allowing the tool stem 20 to be detachably engaged into or disengaged from the engaging hole 13 of the driver shank 10 (FIG. 4) and for allowing either of the two end portions 21, 23 of the tool stem 20 to be selectively or changeably engaged with the engaging hole 13 of the driver shank 10.

A spring biasing means or device 4 may further be provided and attached to the driver shank 10 for engaging with the sleeve 30 and for applying a spring biasing force onto or against the sleeve 30, and includes a tubular member 40 attached or secured onto the end portion 12 of the driver shank 10 with such as a force-fitted engagement, latches or fasteners (not shown), adhesive materials, or by welding processes, and includes a peripheral rib 41 extended radially and outwardly therefrom and located closer to the end portion 12 but distal to the other end portion 11 of the driver shank 10, and includes a peripheral groove 42 formed in the outer peripheral portion thereof for engaging with another clamping or retaining ring 43, and includes a barrel 45 slidably engaged onto the driver shank 10 and disposed between the tubular member 40 and the sleeve 30 for being biased to engage with the sleeve 30 (FIGS. 2-4).

The barrel 45 includes a peripheral recess 46 formed in the inner peripheral portion thereof for engaging with the retaining ring 43 and for limiting the barrel 45 to slide relative to the tubular member 40 and the driver shank 10 and for preventing the barrel 45 from being disengaged from the tubular member 40 and the driver shank 10, and includes a peripheral flange 47 extended radially and inwardly therefrom and located closer to the other end portion 11 but distal to the end portion 12 of the driver shank 10, and a spring biasing member 48 is disposed between the tubular member 40 and the barrel 45 for engaging with the peripheral flange 47 of the barrel 45 and for biasing or forcing the barrel 45 to engage with the sleeve 30, and/or for biasing or disengaging the peripheral depression 34 of the sleeve 30 from the detent 15 or for forcing the sleeve 30 to engage with the detent 15 and to force the detent 15 to engage with the tool stem 20. The peripheral rib 41 of the tubular member 40 may also be used to limit the barrel 45 to slide relative to the tubular member 40 and to prevent the barrel 45 from being disengaged from the tubular member 40.

In operation, as shown in FIG. 4, when the sleeve 30 is moved toward the barrel 45 to force the barrel 45 to engage with the spring biasing member 48 until the peripheral depression 34 of the sleeve 30 is aligned with the detent 15, the detent 15 may be selectively received or engaged in or with the peripheral depression 34 of the sleeve 30 and may be disengaged from the tool stem 20 for allowing either of the two end portions 21, 23 of the tool stem 20 to be selectively or changeably engaged with the engaging hole 13 of the driver shank 10. After the selected end portion 21, 23 of the tool stem 20 is engaged with the engaging hole 13 of the driver shank 10, the spring biasing member 48 may bias or force the barrel 45 to engage with the sleeve 30 and to disengage the peripheral depression 34 of the sleeve 30 from the detent 15 and to force the sleeve 30 to engage with the detent 15 and then to force the detent 15 to engage with the tool stem 20 (FIG. 3).

As shown in FIGS. 5, 6, a screw or fastener 90 is to be engaged into the work piece 98 and is engaged with either of the tool bits or tool members 80, 88 for being rotated or driven by either of the tool bits or tool members 80, 88. At this moment, the sleeve 30 may be moved relative to the driver shank 10 and moved away from the end portion 12 of the driver shank 10 and engaged onto the outer peripheral portion of the fastener 90 for shielding or covering or protecting the fastener 90 and for allowing the fastener 90 to be suitably or safely engaged into the work piece 98 with the driver shank 10 and the tool stem 20, and/or for preventing the fastener 90 from being tilted or inclined relative to the sleeve 30, and/or for preventing the fastener 90 from being interfered by the other objects.

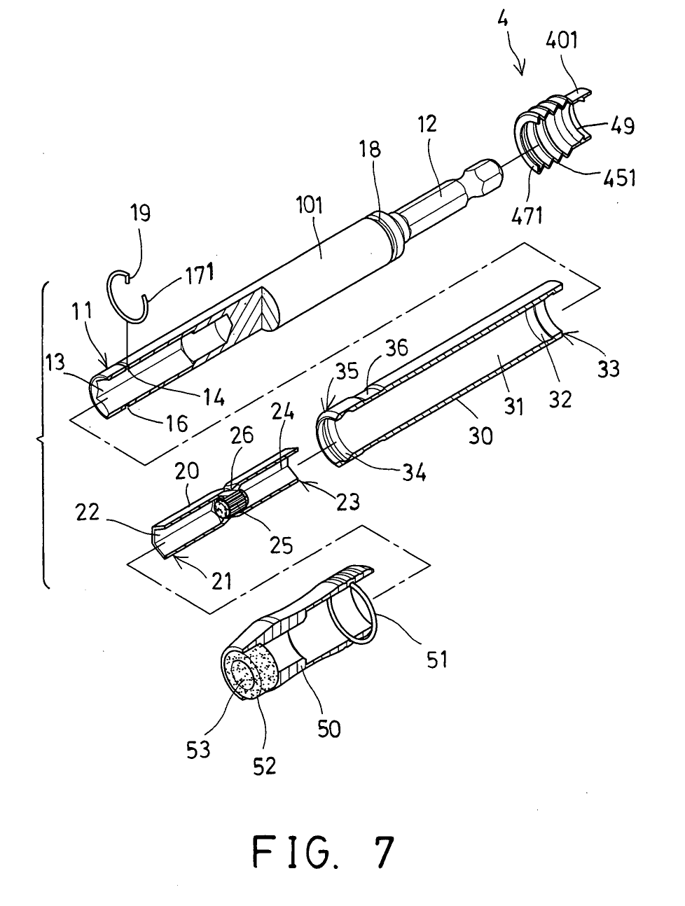

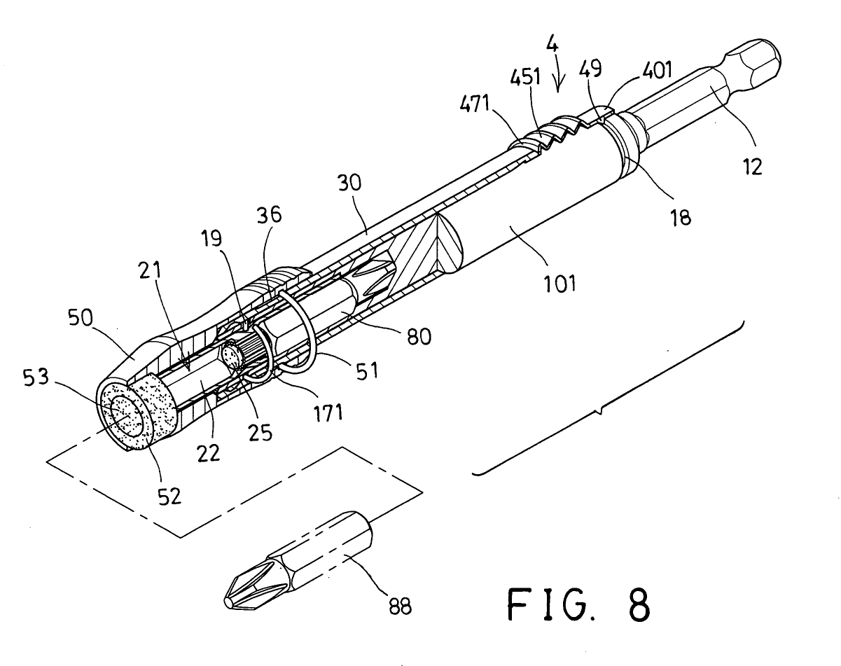

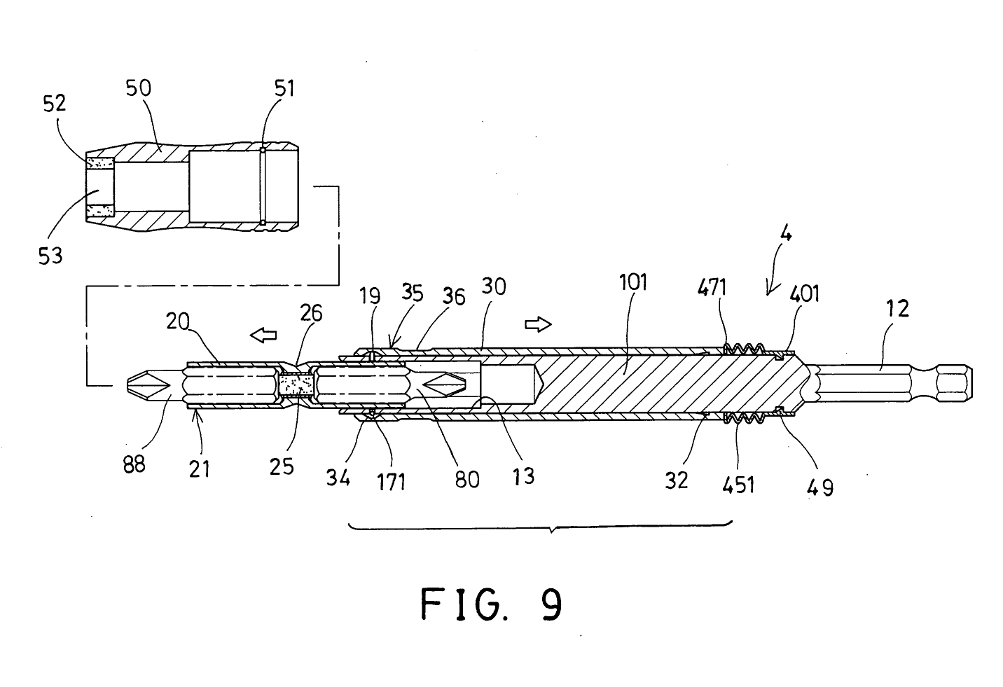

As shown in FIGS. 7-11, a ferrule 50 may further be provided and slidably engaged with or onto the other end portion 35 of the sleeve 30, and includes a clamping or retaining ring 51 attached or secured in the inner peripheral portion thereof, and the sleeve 30 includes a peripheral depression 36 formed in the outer peripheral portion thereof for selectively and slidably receiving or engaging with the retaining ring 51 and for limiting the ferrule 50 to slide relative to the sleeve 30 and for preventing the ferrule 50 from being disengaged from the sleeve 30, and includes another magnetic member 52 disposed or engaged in the other end portion thereof, and the magnetic member 52 includes a bore 53 formed therein for receiving or engaging with either of the tool bits or tool members 80, 88 and for attracting or stably or solidly retaining the fastener 90 to the tool bits or tool members 80, 88 (FIG. 11).

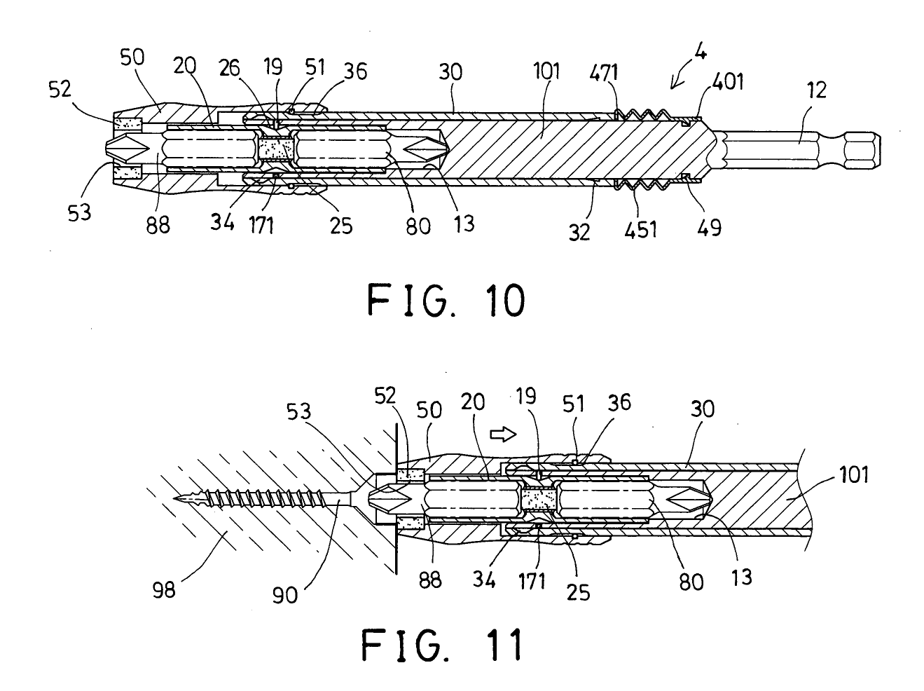

The retaining ring 171 may include a detent 19 formed integral with the retaining ring 171 or bent from the retaining ring 171 or secured to the retaining ring 171 and extendible into the engaging hole 13 of the driver shank 101 for engaging with the peripheral groove 26 of the tool stem 20 (FIGS. 10, 11) and for detachably attaching or anchoring or securing the tool stem 20 to the driver shank 101. The driver shank 101 may further include a peripheral slot 18 formed in outer peripheral portion thereof and located closer to the end portion 12 and distal to the other end portion 11 of the driver shank 101, and the tubular member 401 of the spring biasing means or device 4 may further include a peripheral swelling 49 extended radially and inwardly therefrom and engaged into the peripheral slot 18 of the driver shank 101 for anchoring or securing the tubular member 401 to the driver shank 101.

The tubular member 401 of the spring biasing means or device 4 may further include a bellows type spring biasing member 451 extended therefrom, and includes a peripheral flange 471 extended radially and inwardly therefrom for stably engaging with the sleeve 30 and for applying a spring biasing force onto or against the sleeve 30, and also for biasing or forcing the peripheral flange 471 to engage with the sleeve 30 and to disengage the peripheral depression 34 of the sleeve 30 from the detent 19 and to force the sleeve 30 to engage with the detent 19 and then to force the detent 19 to engage with the tool stem 20 (FIGS. 8, 10-11).

Accordingly, the driver tool in accordance with the present invention may be provided for engaging with and for driving various tool bits or tool members having different sizes or dimensions, types (such as Philips, flat), or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A driver tool comprising:
a driver shank including a first end portion and a second end portion, and including a non-circular engaging hole formed in said first end portion thereof,
a tool stem including two end portions for selectively engaging with said engaging hole of said driver shank, and including a non-circular engaging hole formed in each of said end portions of said tool stem for engaging with tool members,
a magnetic member disposed between said engaging holes of said tool stem for engaging with and for attracting and for retaining the tool members to said tool stem,
a detent slidably engaged in said driver shank and extendible into said engaging hole of said driver shank for engaging with said tool stem and for detachably anchoring and securing said tool stem to said driver shank,
a sleeve slidably engaged onto said driver shank for selectively engaging with said detent and for selectively forcing said detent to engage with said tool stem and for detachably anchoring and securing said tool stem to said driver shank;
a tubular member secured onto said driver shank,
a barrel slidably engaged onto said driver shank and disposed between said tubular member and said sleeve for engaging with said sleeve, and
a spring biasing member disposed between said tubular member and said barrel for engaging with said barrel and for biasing said barrel to engage with said sleeve and for biasing said sleeve to engage with said detent and to force said detent to engage with said tool stem and to anchor said tool stem to said driver shank.

2. (canceled)

3. The driver tool as claimed in claim 1, wherein said tubular member includes a retaining ring disposed on an outer peripheral portion thereof, and said barrel includes an inner peripheral recess formed therein for engaging with said retaining ring and for limiting said barrel to slide relative to said tubular member.

4. The driver tool as claimed in claim 1, wherein said tubular member includes a peripheral rib extended radially and outwardly therefrom for selectively engaging with said barrel and for limiting said barrel to slide relative to said tubular member.

5. The driver tool as claimed in claim 1, wherein said barrel includes an inner peripheral flange for engaging with said spring biasing member.

6. The driver tool as claimed in claim 1, wherein said sleeve includes a peripheral depression formed therein for selectively receiving and engaging with said detent and for allowing said detent to be disengaged from said tool stem and for allowing said tool stem to be detachably engaged into and disengaged from said engaging hole of said driver shank.

7. The driver tool as claimed in claim 1, wherein said sleeve includes a peripheral slot formed therein, and said driver shank includes a retaining ring disposed on an outer peripheral portion thereof for selectively engaging with said peripheral slot of said sleeve and for limiting said sleeve to slide relative to said driver shank and for preventing said sleeve from being disengaged from said driver shank.

8. The driver tool as claimed in claim 1, wherein said tool stem includes a peripheral groove formed in an outer peripheral portion thereof for engaging with said detent and for allowing said tool stem to be stably anchored and secured to said driver shank with said detent.

9. The driver tool as claimed in claim 1, wherein said second end portion of said driver shank includes a non-circular cross section.
